(19) United States
(12) Patent Application Publication
(10) Pub. No.: US 2016/0248908 A1
(43) Pub. Date: Aug. 25, 2016

(54) VOICE GARBLING DETECTION USING SILENCE INSERTION DESCRIPTOR FRAMES

(71) Applicant: QUALCOMM Incorporated, San Diego, CA (US)

(72) Inventors: Sitaramanjaneyulu KANAMARLAPUDI, San Diego, CA (US); Liangchi HSU, San Diegoo, CA (US); Chetan CHAKRAVARTHY, San Diego, CA (US)

(21) Appl. No.: 14/829,892

(22) Filed: Aug. 19, 2015

Related U.S. Application Data
(60) Provisional application No. 62/120,031, filed on Feb. 24, 2015.

(51) Int. Cl. H04M 3/22; H04W 56/00

(52) U.S. Cl. CPC H04M 3/2236; H04W 56/003; H04M 3/2227; H04W 88/02

(57) ABSTRACT

Systems, methods, and apparatuses for detecting voice distortion are disclosed. In some aspects, a communication device may decode a silence insertion descriptor (SID) frame to identify a pattern associated with the SID frame and correlate the pattern with a reference pattern for the SID frame. Based on the correlating, the communication device, in some examples, may determine whether the SID frame is de-synchronized. In one or more examples, determining whether the SID frame is de-synchronized may comprise determining that a consecutive N number of SID frames fail to match the reference pattern. Additionally or alternatively, the communication device may adjust at least one parameter to re-synchronize a voice signal associated with the SID frame upon determining that the SID frame is de-synchronized.

### CROSS-REFERENCE TO RELATED APPLICATION(S)

This application claims priority to U.S. Provisional Application Ser. No. 62/120,031, entitled, “VOICE GARBLING DETECTION USING SILENCE INSERTION DESCRIPTOR FRAMES,” and filed on Feb. 24, 2015, which is assigned to the assignee hereof and hereby expressly incorporated by reference herein in its entirety.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., an LTE system).

By way of example, a wireless multiple-access communications system may include a number of base stations, each simultaneously supporting communication for multiple communication devices, which may be otherwise known as user equipment (UEs), mobile devices or stations (STAs). A base station may communicate with the communication devices on downlink channels (e.g., for transmissions from a base station to a UE) and uplink channels (e.g., for transmissions from a UE to a base station).

In some cases, the voice quality (e.g., during phone calls) may deteriorate based on, for example, poor channel conditions or de-synchronization between the transmitting device and the receiving device. It should be appreciated that the transmitting device and/or the receiving device may be an example of communication devices described above. As a result, in some examples, user experience during voice communication may be negatively impacted due to the reduced voice quality. Conventional methods are unable to effectively detect and identify deterioration of voice quality, and thus cure the degradation.

### SUMMARY

System, method, and apparatus for detecting voice distortion are disclosed. In some aspects, a communication device may decode a silence insertion descriptor (SID) frame to identify a pattern associated with the SID frame and correlate the pattern with a reference pattern for the SID frame. Based on the correlating, the communication device, in some examples, may determine whether the SID frame is de-synchronized. In one or more examples, determining whether the SID frame is de-synchronized may comprise determining that a consecutive N number of SID frames fail to match the reference pattern. Additionally or alternatively, the communication device may adjust at least one parameter to re-synchronize a voice signal associated with the SID frame upon determining that the SID frame is de-synchronized.

In accordance with an illustrated example, a method for wireless communication is disclosed. The method may comprise decoding, at a communication device, a SID frame to identify a pattern associated with the SID frame, and correlating the pattern with a reference pattern for the SID frame. Based on the correlating, the communication device may determine whether the SID frame is de-synchronized.

In accordance with another illustrated example, an apparatus for wireless communication is disclosed. The apparatus may include means for decoding, at a communication device, the SID frame to identify a pattern associated with the SID frame. The apparatus may further include means for correlating the pattern with a reference pattern for the SID frame, and means for determining whether the SID frame is de-synchronized based on the correlating.

In accordance with another illustrated example, another apparatus for wireless communication is disclosed. The apparatus may include a processor and a memory coupled to the processor. The memory may include instructions executable by the processor to decode, at a communication device, the SID frame to identify a pattern associated with the SID frame, and correlate the pattern with a reference pattern for the SID frame. The apparatus may further determine whether the SID frame is de-synchronized based on the correlating.

In accordance with yet another illustrated example, a computer-readable medium storing code for wireless communication id disclosed. The computer-readable medium may include code for decoding, at a communication device, the SID frame to identify a pattern associated with the SID frame and a code for correlating the pattern with a reference pattern for the SID frame. In some examples, the computer-readable medium may further include code for determining whether the SID frame is de-synchronized based on the correlating.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional component, and in which:

FIG. 1 is a schematic diagram of a communication network including an aspect of a UE that may detect voice distortion based on SID frames in accordance with various aspects of the present disclosure;

FIG. 2 is a flowchart illustrating a method of detecting de-synchronization in accordance with various aspects of the present disclosure; and

FIG. 3 illustrates an example of a wireless communications system for detecting voice distortion based on SID frames in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It should be understood, however, that such aspect(s) may be practiced without these specific details.

As discussed above, in some cases, the voice quality (e.g., during phone calls) may deteriorate based on, for example, poor channel conditions between the transmitting device and the receiver device. As a result, a user's experience during voice communication may be negatively impacted due to the reduced voice quality. One reason for poor voice quality may be due to de-synchronization between the transmitting device and the receiving device that may result from one or more packet losses. Some systems attempt to maintain synchronization between a transmitting device and the receiving device by utilizing sequence number parameters (e.g., ciphering sequence number Count-C) that are maintained at each of the transmitting device and the receiving device to identify possibly lost packets.

In a typical network configuration mobile users communicate with each other via communication links maintained by the network. In this regard, for example, an originating station may typically communicate data to network devices in order for the network devices to relay the data to a target station. The quality of service (QoS) of the radio links may be managed by an entity referred to as a radio link controller (RLC). The RLC may manage QoS of each radio bearer and the transmission of data of each radio bearer via different types of RLC modes. Some examples of modes may include a transparent mode (TM), an acknowledged mode (AM) and an unacknowledged mode (UM). Each mode may support a corresponding different QoS.

For example, transparent mode may be a mode in which no overhead is attached to an RLC service data unit (SDU) received from a higher layer when constituting a protocol data unit (PDU). As such, the RLC may pass the SDU in a transparent manner. In non-transparent modes like acknowledged mode and unacknowledged mode, overhead is added at the RLC. In acknowledged mode, the acknowledged mode RLC constitutes a PDU by adding a PDU header that includes a sequence number that can be used by the receiver to determine whether a PDU has been lost during transmission. The receiver also provides acknowledgement for PDUs received and thus re-transmission may be requested for PDUs that were not received in order to improve efforts to provide error-free data transmission via re-transmissions when necessary.

Due to the potential for re-transmissions, acknowledgment mode may be better suited for non-real-time packet transmissions. Unacknowledged mode, unlike acknowledged mode, does not provide acknowledgement for PDUs received. Thus, although the receiver may still use a sequence number provided in the PDU header to determine whether any PDU has been lost, the transmitter receives no acknowledgements for PDUs transmitted and therefore does not check whether the receiver is properly receiving transmitted PDUs. Thus, once a PDU is transmitted, the PDU is typically not retransmitted. Due to the fact that unacknowledged mode does not provide re-transmissions of PDUs, unacknowledged mode may be more suitable to real-time packet transmissions such as voice over Internet protocol (VoIP), broadcast/multicast data and other real-time services. Circuit switched (CS) voice calls may be an example of a service for which unacknowledged mode may provide network support.

In particular, CS voice over high speed packet access (HSPA) has been introduced for WCDMA (wideband code division multiple access) in order to attempt to improve frequency efficiency and battery life by mapping CS voice services on high speed uplink packet access (HSUPA) and high speed downlink packet access (HSDPA). As such, for example, a CS voice over HSPA radio access bearer (RAB) may be mapped on a UM RLC and an adaptive multi-rate (AMR) voice codec may send audio frames, for example, for each 20 ms if audio data exists or send an silence descriptor (SID) frame for each 160 ms if no audio data exists (e.g., in silent periods).

Despite the potential for utility of TM and UM in applications such as those described above, a ciphering problem may occur when the receiver fails to receive a certain number of consecutive data PDUs. For example, if the receiver fails to receive more than 127 consecutive data PDUs, the receiver may miss the timing to increment a hyper frame number (HFN) value so that COUNT-C values in the receiver and the transmitter may fall out of synchronization. Some exemplary situations in which the ciphering problem is encountered may include cases of bad radio conditions, hard handoffs, a fallback after a hard handoff, or a fallback after an intersystem handover to GSM (global system for mobile communication) failure. In other examples, the ciphering problem may occur if the network keeps sending data PDUs and the user equipment (UE) or mobile terminal of the user keeps failing to receive the UM data PDUs for a period of about 2.56 seconds in the downlink direction, or if the UE keeps sending data PDUs and the network keeps failing to receive the UM data PDUs for 1.28 seconds in the uplink direction.

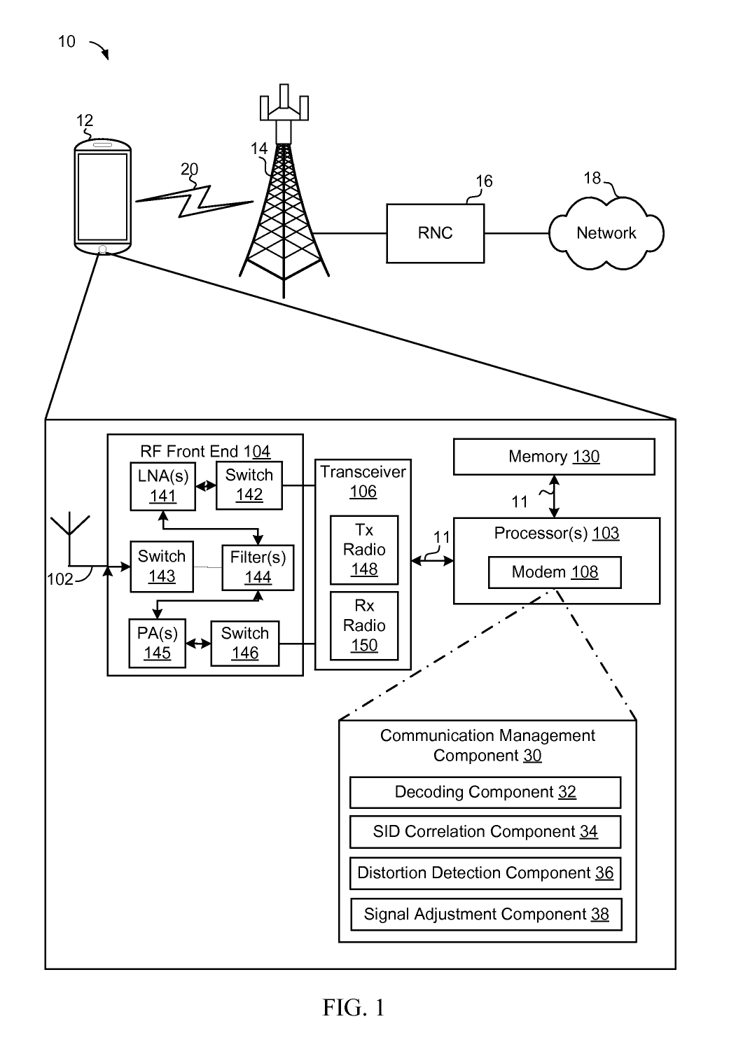

In accordance with aspects of the present disclosure, a communication device (e.g., UE 12 or base station 14 illustrated in FIG. 1) may detect potential de-synchronization between the transmitter and receiver or deterioration in voice quality based on SID frames associated with the voice communication. Unlike digitized voice packets that may vary based on factors such as voice pitch, tone, or language, SID frames exhibits a standardized sequence or pattern. Thus, in accordance with aspects of the present disclosure, the known properties or characteristics of the SID frames may be used to determine whether the SID frame is de-synchronized, which indicates de-synchronization between the transmitter and receiver, and initiate corrective measures. Specifically, in accordance with aspects of the present disclosure, if the communication device determines that the SID frame is de-synchronized based on the correlation of the received SID frame against a reference pattern of the SID frame, the communication device may infer that the voice signal associated with the SID frame may also be de-synchronized, and thus the voice communication may be distorted or garbled.

Referring to FIG. 1, in an aspect, a wireless communication system 10 includes at least one UE 12 in communication coverage of at least one network entity 14 (e.g., base station or node B). UE 12 can communicate with a network 18 via network entity 14 and a radio network control (RNC) 16. In an aspect, UE 12 may include one or more processors 103 that may operate in combination with the communication management component 30 operable to detect de-synchronization during a voice call between the transmitting device and the receiving device based on SID frames. In some examples, UE 12 may be a receiving device that may establish a voice call with another UE 12 (not shown) through the network entity 14. Accordingly, the UE 12 (receiving device) may receive SID frames from another UE 12 (transmitting device) via the network entity 14 to identify de-synchronization during a voice call. Although FIG. 1 describes the implementation of communication management component 30 with respect to the functionalities of a UE 12, it should be appreciated by those skilled in the art that the similar implementations may be adopted in a network entity 14 to detect distortion in voice calls and correct potential de-synchronization between the transmitting device and the receiving device.

In an aspect, the network entity 14 may be a base station such a NodeB in an UMTS network. UE 12 may communicate with a network 18 via network entity 14 and a radio network controller (RNC) 16. In some aspects, multiple UEs including UE 12 may be in communication coverage with one or more network entities, including network entity 14. In an example, UE 12 may transmit and/or receive wireless communications 20 to and/or from network entity 14.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 12 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

The wireless communications 20 between the UE 12 and the network entity 14 may include signals transmitted by either the network entity 14 or the UE 12. The wireless communications 20 can include downlink channels transmitted by the network entity 14. For example, the network entity 14 may transmit a high-speed downlink shared channel (HS-DSCH), high-speed physical downlink shared channel (HS-PDSCH), downlink dedicated physical control channel (DL-DPCCH), or a fractional dedicated physical channel (F-DPCH).

In an aspect, the one or more processors 103 can include a modem 108 that uses one or more modem processors. The various functions related to communication management component 30 may be included in modem 108 and/or processors 103 and, in an aspect, can be executed by a single processor, while in other aspects, different ones of the functions may be executed by a combination of two or more different processors. For example, in an aspect, the one or more processors 103 may include any one or any combination of a modem processor, or a baseband processor, or a digital signal processor, or a transmit processor, or a transceiver processor associated with transceiver 106. In particular, the one or more processors 103 may execute functions and components included in communication management component 30, including a decoding component 32 for decoding one or more packets received from the network device, SID correlation component 34 for correlating the received SID frame with the known pattern or properties of a reference SID frame, distortion detection component 36 for detecting distortion (e.g., voice garbling), and a signal adjustment component 38 for adjusting at least one parameter (e.g., ciphering sequence number) to cure, remedy, or otherwise counter the distortion.

According to the present aspects, communication management component 30 may include hardware and/or software executable by a processor (e.g., processor 103) for processing messages received through wireless communications channel 20 in order to detect potential de-synchronization between the transmitting device and the UE 12 during voice calls. In an aspect, the term “component” as used herein may be one of the parts that make up a system, may be hardware, firmware, and/or software, and may be divided into other components.

As noted above, the communication management component 30 may include the decoding component 32 configured to decode at least one SID frame (e.g., SID_first frame or SID_update frame) to identify a sequence or pattern associated with the SID frame. In some instances, the decoding of the SID frame may be triggered in response to detecting an SID bad_frame at the communication device (e.g., UE 12 or network entity 105). The decoding component 32 may comprise hardware, firmware, and/or software and may be configured to execute code or perform instructions stored in a memory (e.g., a computer-readable storage medium

Additionally or alternatively, the communication management component 30 may include an SID correlation component 34. The SID correlation component 34 may be configured to correlate the identified pattern associated with the SID frame with at least one reference pattern or sequence. In some examples, the reference pattern or sequence may include at least one known characteristics or property of the SID frame. In some examples, the SID correlation component 34 may compare the pattern at the MAC layer or the RLC layer. The SID correlation component 34 may comprise hardware, firmware, and/or software and may be configured to execute code or perform instructions stored in a memory (e.g., a computer-readable storage medium

In further examples, the communication management component 30 may include a distortion detection component 36 configured to determine whether the SID frame is de-synchronized based on the correlation. For example, the distortion detection component 36 may indicate that the SID frame is de-synchronized if the identified sequence or pattern of the SID frame fails to match a reference sequence or pattern. In some examples, the determination may be based on a consecutive N number of SID frames failing to match the reference pattern, where N may be an integer greater than one (1). If the SID frame is de-synchronized, the communication management component 30 may infer that the voice signal associated with the SID frame and the voice communication may also be de-synchronized, and thus may be distorted or garbled. The distortion detection component 36 may comprise hardware, firmware, and/or software and may be configured to execute code or perform instructions stored in a memory (e.g., a computer-readable storage medium

Based on the determination of the distortion detection component 36, the signal adjustment component 38 may be configured to initiate signal correction procedures. In some examples, the signal correction procedures may include adjusting at least one parameter (e.g., ciphering sequence number) of the receiver device (e.g., UE 12) or the transmitting device (e.g., another UE 12 or network entity 14). As such, the signal adjustment component 38 may transmit signaling information to an external communication device to force re-synchronization of at least one parameter at the external communication device. In some aspects, forcing re-synchronization of at least one parameter may include adjusting at least one of a short sequence number (e.g., 7-bit RLC sequence number) and/or a long sequence number (e.g., 25-bit HFN that is incremented at each RLC sequence number cycle). The signal adjustment component 38 may comprise hardware, firmware, and/or software and may be configured to execute code or perform instructions stored in a memory (e.g., a computer-readable storage medium

Moreover, in an aspect, UE 12 may include RF front end 104 and transceiver 106 for receiving and transmitting radio transmissions, for example, wireless communications 20 transmitted by the network entity 14. In some aspects, the transceiver 106 may include transmitter radio 148 for transmitting radio transmissions to the network device 14, for example. Additionally or alternatively, the transceiver 106 may also include a receiver radio 150 for receiving radio transmission, including one or more SID frames. For example, transceiver 106 may receive a packet transmitted by another UE via the network entity 14. UE 12, upon receipt of an entire message, may decode the message and perform a cyclic redundancy check (CRC) to determine whether the packet was received correctly. For example, transceiver 106 may communicate with modem 108 to transmit messages generated by communication management component 30 and to receive messages and forward them to communication management component 30.

RF front end 104 may be connected to one or more antennas 102 and can include one or more low-noise amplifiers (LNAs) 141, one or more switches 142, 143, 145, one or more power amplifiers (PAs) 145, and one or more filters 144 for transmitting and receiving RF signals on the uplink channels 173 and downlink channels 171. In an aspect, components of RF front end 104 can connect with transceiver 106. Transceiver 106 may connect to one or more modems 108 and processor 103.

In an aspect, LNA 141 can amplify a received signal at a desired output level. In an aspect, each LNA 141 may have a specified minimum and maximum gain values. In an aspect, RF front end 104 may use one or more switches 142, 143 to select a particular LNA 141 and its specified gain value based on a desired gain value for a particular application.

Further, for example, one or more PA(s) 145 may be used by RF front end 104 to amplify a signal for an RF output at a desired output power level. In an aspect, each PA 145 may have a specified minimum and maximum gain values. In an aspect, RF front end 104 may use one or more switches 143, 146 to select a particular PA 145 and its specified gain value based on a desired gain value for a particular application.

Also, for example, one or more filters 144 can be used by RF front end 104 to filter a received signal to obtain an input RF signal. Similarly, in an aspect, for example, a respective filter 144 can be used to filter an output from a respective PA 145 to produce an output signal for transmission. In an aspect, each filter 144 can be connected to a specific LNA 141 and/or PA 145. In an aspect, RF front end 104 can use one or more switches 142, 143, 146 to select a transmit or receive path using a specified filter 144, LNA, 141, and/or PA 145, based on a configuration as specified by transceiver 106 and/or processor 103.

Transceiver 106 may be configured to transmit and receive wireless signals through antenna 102 via RF front end 104. In an aspect, transceiver may be tuned to operate at specified frequencies such that UE 12 can communicate with, for example, network entity 130. In an aspect, for example, modem 108 can configure transceiver 106 to operate at a specified frequency and power level based on the UE configuration of the UE 12 and communication protocol used by modem 108.

In an aspect, modem 108 can be a multiband-multimode modem, which can process digital data and communicate with transceiver 106 such that the digital data is sent and received using transceiver 106. In an aspect, modem 108 can be multiband and be configured to support multiple frequency bands for a specific communications protocol. In an aspect, modem 108 can be multimode and be configured to support multiple operating networks and communications protocols. In an aspect, modem 108 can control one or more components of UE 12 (e.g., RF front end 104, transceiver 106) to enable transmission and/or reception of signals from the network based on a specified modem configuration. In an aspect, the modem configuration can be based on the mode of the modem and the frequency band in use. In another aspect, the modem configuration can be based on UE configuration information associated with UE 12 as provided by the network during cell selection and/or cell reselection.

UE 12 may further include a memory 130, such as for storing data used herein and/or local versions of applications or communication management component 30 and/or one or more of its subcomponents being executed by processor 103. Memory 130 can include any type of computer-readable medium usable by a computer or processor 103, such as random access memory (RAM), read only memory (ROM), tapes, magnetic discs, optical discs, volatile memory, non-volatile memory, and any combination thereof. In an aspect, for example, memory 130 may be a computer-readable storage medium that stores one or more computer-executable codes defining communication management component 30 and/or one or more of its subcomponents, and/or data associated therewith, when UE 12 is operating processor 103 to execute channel messaging component 30 and/or one or more of its subcomponents. Additionally or alternatively, the UE 12 may include a bus 11 for coupling the RF front end 104, transceiver 106, memory 130 and processor 103 and to exchange signaling information between each of the components and/or subcomponents of the UE 12.

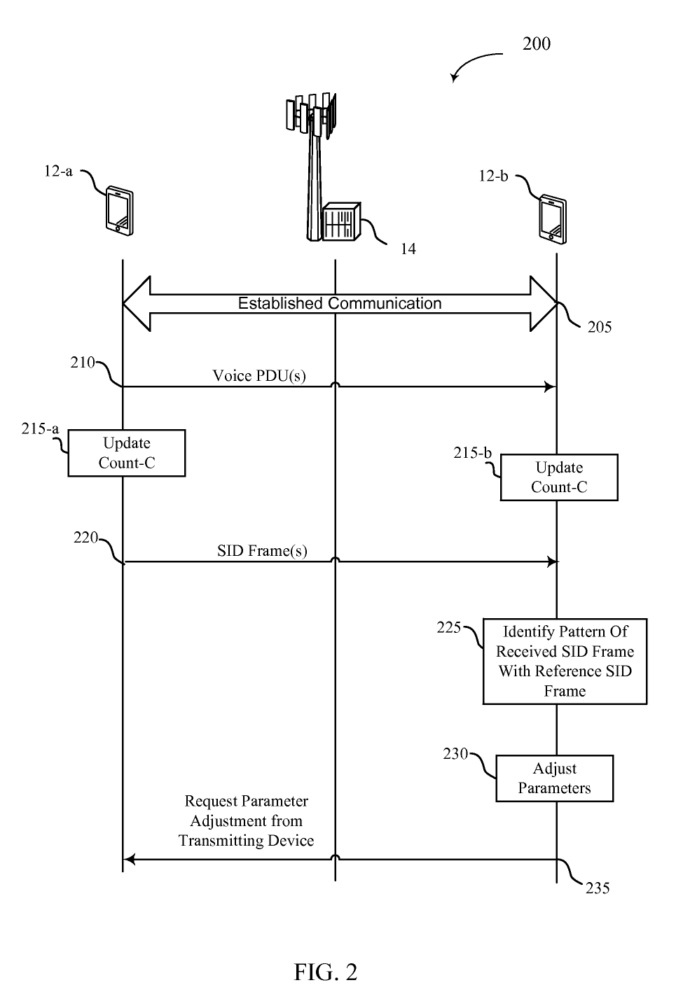

FIG. 2 illustrates a system 200 of detecting de-synchronization between a transmitting device (e.g., UE 12-a) and receiving device (e.g., UE 12-b) based on the SID frames. System 200 may include one or more UEs 12 that may be an example of UEs 12 described with reference to FIG. 1. Additionally, system 200 may include a network entity 14 (e.g., base station) that may be an example of network entity 14 described with reference to FIG. 1

As discussed above, a ciphering problem may occur when the receiver fails to receive a certain number of consecutive data PDUs. In RLC, ciphering and deciphering are performed on transmitted packets by utilizing a time-varying parameter value or count referred to as COUNT-C, which is a combination of a short sequence number (SN) and a long SN. The short SN is a 7-bit RLC SN that is part of the protocol data unit (PDU) header. The long SN is a 25-bit HFN that is incremented at each RLC SN cycle. Accordingly, upon transmitting every 127 consecutive PDUs, an RLC SN cycle at the transmitting device is completed, the RLC SN at the transmitting device wraps around, and the HFN at the transmitting device is incremented. Meanwhile, if the receiving device misses more than 127 consecutive PDUs, for example, because the receiving device is not aware of the missed PDUs, the HFN at the receiving RLC UM entity is not incremented, resulting in a de-synchronization between the HFNs at the transmitting and receiving devices. Thereafter, even if further PDUs are transmitted and received correctly, the data in the received RLC PDUs will be erroneously deciphered at the receiving device due to the de-synchronization between the HFNs at the transmitting and receiving devices. Since the transmitting and receiving devices will not be able to detect such error, the corrupted PDUs will be forwarded to higher layers that can result in incorrect service data unit (SDU) generation or garbled voice in, e.g., voice over HSPA applications. Therefore, in some aspects, the communication management component 30 in combination with the processor 103 may detect the de-synchronization by detecting patterns associated Silence Insertion Descriptor (SID) frames and modify one or more parameters (e.g., COUNT-C and/or HFN) to re-synchronize the UE 12-a and the UE 12-b.

SID frames may be transmitted and received at the beginning of an interval of silence during a voice call between multiple communication devices. Specifically, during a voice call, analog audio and voice signals are first converted to a digital signal and subsequently compressed in the form of a pulse code modulated (PCM) digital stream to be transmitting over the network. However, converting and transmitting every aspect of a voice call, including periods of silence may be bandwidth intensive. Various techniques have been developed to reduce the amount of bandwidth used in the transmission of voice packets. One of these techniques reduces the number of transmitted packets by suspending transmission during periods of silence or when only noise is present. Thus, during periods of silence or inactivity, an SID frame (e.g., SID_first frame) may be transmitted from the transmitting device to the receiving device in lieu of transmitting actual silence signal. Generally, SID packets contain a signature of the background noise information with a minimal number of bits in order to utilize limited network resources. On the receiving side, for each frame, the decoder reconstructs a voice or a noise signal depending on the received information. If the received information contains voice parameters, the decoder reconstructs a voice signal. If the decoder receives no information, it generates noise with noise parameters embedded in the previously received SID packet. This process is called Comfort Noise Generation (CNG). If the decoder is muted during the silent period, there will be sudden drops of the signal energy level, which causes unpleasant conversation. Therefore, CNG may be essential to mimic the background noise on the transmitting side. If the decoder receives an updated SID packet (e.g., SID_update frame), it updates its noise parameters for the current and future CNG until the next SID is received.

Therefore, as illustrated in FIG. 2, UE 12-a (the transmitting device) and UE 12-b (the receiving device) may have an established communication at 205 via network entity 14 to facilitate voice communication between the multiple communication devices. During the process of a voice call, UE 12-a may convert audio and voice data observed at UE 12-a to digital data for transmission to the UE 12-b. At 210, the digital data packets may be transmitted to the UE 12-b as one or more PDUs. In order to maintain synchronization and to determine whether any packets have been dropped during the transmission between UE 12-a and UE 12-b, the transmitting device may update one or more parameters such as ciphering sequence number (e.g., COUNT-C) at 215-a. Updating the local parameters may include updated one of short SN or long SN based on the number of PDUs transmitted. At 215-b, upon receiving the one or more PDUs, the receiving device may decode the PDUs and update the ciphering sequence number at the receiving device 12-b.

Subsequently, during periods of silence, UE 12-a, at 220, may transmit one or more SID frames as discussed above to minimize the bandwidth utilization. In some aspects, SID frames (e.g., SID_first frame or SID_update frame) may exhibit a known pattern, characteristic, or property (e.g., frame format and embedded noise signal). In aspects of the present disclosure, the SID frame properties may be leveraged to detect potential de-synchronization issues between the transmitting device and the receiving device. For example, if the UE 12-b receives an SID frame from UE 12-a, the communication management component 30 in UE 12-b, at 225, may determine whether the received SID frame correlates with a reference SID frame based at least in part on known properties or patterns of the SID frame. If the communication management component 30 determines that the received SID frame fails to correspond with the reference SID frame, the communication management component 30 may determine that the UE 12-b is de-synchronized from UE 12-a (i.e., the transmitting side). In some aspects, the communication management component 30 may determine that the UE 12-b is de-synchronized if a consecutive N number of SID frames fail to match the reference pattern. In some examples, N may be an integer (e.g., 2, 3, 4, etc.).

Accordingly, in some examples, the communication management component 30 may adjust at least one parameter to re-synchronize a voice signal associated with the SID frame by adjusting the ciphering sequence number (e.g., parameters identified in 215-b located at the UE 12-b. Additionally or alternatively, the communication management component 30, at 235, may generate signaling information to be exchanged between the UE 12-a and the network entity 14 to force re-synchronization of one or more parameters that may contribute to the ciphering sequence number. For example, the UE 12-b via the signaling information at 235 may request the UE 12-a to modify or adjust one or more parameters identified in 215-a and located at the UE 12-a to re-synchronize voice communication between the UE 12-a and UE 12-b. In some examples, adjusting one or more parameters may include adjusting at least one of a short sequence number (e.g., 7-bit RLC sequence number) and/or a long sequence number (e.g., 25-bit HFN that is incremented at each RLC sequence number cycle) associated with time-varying parameter value or count referred to as COUNT-C. The value of the ciphering sequence number may be adjusted based on a predefined sequence or on a trial and error basis.

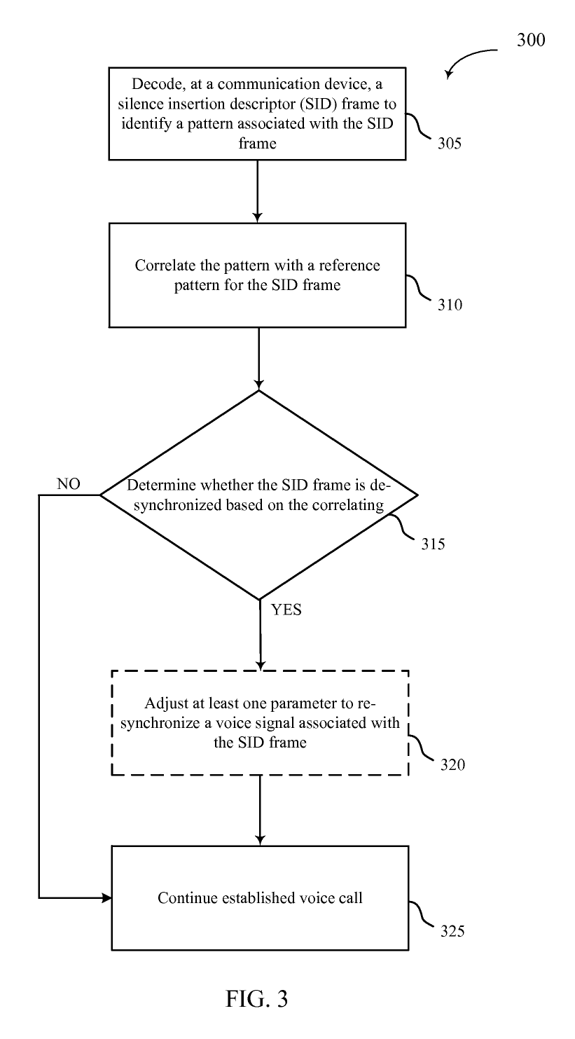

FIG. 3 is a flowchart illustrating a method 300 for detecting voice distortion based on SID frames in accordance with various aspects of the present disclosure. In some examples, the method 300 may be implemented by one or more communication device comprising a communication management component 30 (see FIG. 1). Aspects of a communication device may include a UE 12 or a network entity 14 described with reference to FIG. 1.

At block 305, a communication device may decode a SID frame to identify a pattern associated with the SID frame. The SID frame may be one of a SID_First frame or an SID_updated frame. In some instances, aspects of block 305 may be triggered in response to detecting at least one SID bad-frame. Aspects of block 305 may be performed by decoding component 32 described with reference to FIG. 1.

At block 310, the communication device may correlate the identified pattern with a reference pattern for the SID frame. The reference pattern may comprise at least one known characteristic of the SID frame. In some examples, the characteristics may include a reference pattern for the communication device to correlate the identified pattern again. In some aspects, the communication device may compare the identified pattern associated with the SID frame with the reference pattern at a media access control (MAC) layer or a radio link control (RLC) layer. Aspects of block 310 may be performed by the SID correlation component 34, which is described with reference to FIG. 1.

At block 315, the communication device may determine whether the SID frame is de-synchronized based on the correlating. Determining whether SID frame is de-synchronized may include determining that a consecutive N number of SID frames fail to match the reference pattern. In some examples, N may be an integer greater than one (1). Therefore, if identified patterns of two or more consecutive SID frames fail to match the reference patterns or sequences, the communication device may determine that the SID frame is de-synchronized. Aspects of block 315 may be performed by the distortion detection component 36 described with reference to FIG. 1.

In some examples, if the communication device determines that the SID frame is de-synchronized, may further determine or infer that the voice signal associated with the SID frame (i.e., same voice communication) may also be distorted or de-synchronized. As a result, the communication device, at block 320, may initiate corrective measures such as adjusting at least one parameter to re-synchronize the voice signal. In some aspects, at least one parameter may include a ciphering sequence number (count-c). In some examples, the corrective measures may be performed by the signal adjustment component 38 described with reference to FIG. 1. Signaling information may be exchanged between the UE 12 and the network entity 14 to force re-synchronization of one or more parameters that may contribute to the ciphering sequence number. In some examples, forcing re-synchronization of one or more parameters may include adjusting one or more parameters may include adjusting at least one of a short sequence number (e.g., 7-bit RLC sequence number) and/or a long sequence number (e.g., 25-bit HFN that is incremented at each RLC sequence number cycle) associated with time-varying parameter value or count referred to as COUNT-C. The value of the ciphering sequence number may be adjusted based on a predefined sequence or on a trial and error basis. Accordingly, at block 325, the communication device (e.g., UE 12 and/or network entity 14) may continue the established voice call between the transmitting device and the receiving device.

The detailed description set forth above in connection with the appended drawings describes example embodiments and does not represent all the embodiments that may be implemented or that are within the scope of the claims. The term “exemplary,” as used in this description, means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or “as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile Communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method for wireless communications, comprising:
decoding, at a communication device, a silence insertion descriptor (SID) frame to identify a pattern associated with the SID frame;
correlating the pattern with a reference pattern for the SID frame; and
determining whether the SID frame is de-synchronized based on the correlating.

2. The method of claim 1, wherein determining whether the SID frame is de-synchronized comprises determining that a consecutive N number of SID frames fail to match the reference pattern, wherein N is an integer.

3. The method of claim 1, wherein the decoding of the SID frame to identify the pattern associated with the SID frame is triggered in response to detecting an SID bad-frame.

4. The method of claim 1, wherein correlating the pattern with the reference pattern for the SID frame comprises:
comparing the pattern associated with the SID frame with the reference pattern for the SID frame at a media access control (MAC) layer or a radio link control (RLC) layer.

5. The method of claim 1, wherein when a determination is made that the SID frame is de-synchronized, the method further comprises:
adjusting at least one parameter to re-synchronize a voice signal associated with the SID frame, wherein the at least one parameter includes a ciphering sequence number.

6. The method of claim 1, wherein when a determination is made that the SID frame is de-synchronized, the method further comprises:
transmitting signaling information to an external communication device to force re-synchronization of at least one parameter at the external communication device, wherein forcing re-synchronization includes adjusting at least one of a short sequence number or a long sequence number associated with COUNT-C time-varying parameter value.

7. The method of claim 1, wherein the SID frame is one of a SID_First frame or an SID_Update frame.

8. The method of claim 1, wherein determining whether the SID frame is de-synchronized comprises determining that a voice signal associated with the SID frame is distorted.

9. The method of claim 1, wherein the communication device is a user equipment or a network device.

10. An apparatus for wireless communications, comprising:
means for decoding, at a communication device, a silence insertion descriptor (SID) frame to identify a pattern associated with the SID frame;
means for correlating the pattern with a reference pattern for the SID frame; and
means for determining whether the SID frame is de-synchronized based on the correlating.

11. The apparatus of claim 10, wherein the means for determining whether the SID frame is de-synchronized comprises means for determining that a consecutive N number of SID frames fail to match the reference pattern, wherein N is an integer.

12. The apparatus of claim 10, wherein the means for decoding the SID frame to identify the pattern associated with the SID frame is triggered in response to detecting an SID bad-frame.

13. The apparatus of claim 10, wherein means for correlating the pattern with the reference pattern for the SID frame comprises:
means for comparing the pattern associated with the SID frame with the reference pattern for the SID frame at a media access control (MAC) layer or a radio link control (RLC) layer.

14. The apparatus of claim 10, further comprising:
means for adjusting at least one parameter to re-synchronize a voice signal associated with the SID frame when a determination is made that the SID frame is de-synchronized, wherein the at least one parameter includes a ciphering sequence number.

15. The apparatus of claim 10, further comprising:
means for transmitting signaling information to an external communication device to force re-synchronization of at least one parameter at the external communication device, wherein forcing re-synchronization includes adjusting at least one of a short sequence number or a long sequence number associated with COUNT-C time-varying parameter value.

16. The apparatus of claim 10, wherein the SID frame is one of a SID_First frame or an SID_Update frame.

17. The apparatus of claim 10, wherein means for determining whether the SID frame is de-synchronized comprises means for determining that a voice signal associated with the SID frame is distorted.

18. The apparatus of claim 10, wherein the communication device is a user equipment or a network device.

19. An apparatus for wireless communication, comprising:
a transceiver configured to receive data on a downlink channel, and to transmit uplink data transmissions on an uplink channel;
a memory configured to store code with instructions; and
at least one processor communicatively coupled to the memory and the transceiver via a bus, the at least one processor configured to execute the code to:
decode, at a communication device, a silence insertion descriptor (SID) frame to identify a pattern associated with the SID frame;
correlate the pattern with a reference pattern for the SID frame; and
determine whether the SID frame is de-synchronized based on the correlating.

20. The apparatus of claim 19, wherein determining whether the SID frame is de-synchronized comprises determining that a consecutive N number of SID frames fail to match the reference pattern, wherein N is an integer.

21. The apparatus of claim 19, wherein the decoding of the SID frame to identify the pattern associated with the SID frame is triggered in response to detecting an SID bad-frame.

22. The apparatus of claim 19, wherein correlating the pattern with the reference pattern for the SID frame comprises:
comparing the pattern associated with the SID frame with the reference pattern for the SID frame at a media access control (MAC) layer or a radio link control (RLC) layer.

23. The apparatus of claim 19, wherein the at least one processor is further configured to:
adjust at least one parameter to re-synchronize a voice signal associated with the SID frame when a determination is made that the SID frame is de-synchronized, wherein the at least one parameter includes a ciphering sequence number.

24. The apparatus of claim 19, wherein the at least one processor is further configured to:
transmit signaling information to an external communication device to force re-synchronization of at least one parameter at the external communication device, wherein forcing re-synchronization includes adjusting at least one of a short sequence number or a long sequence number associated with COUNT-C time-varying parameter value.

25. The apparatus of claim 19, wherein the SID frame is one of a SID_First frame or an SID_Update frame.

26. The apparatus of claim 19, wherein determining whether the SID frame is de-synchronized comprises determining that a voice signal associated with the SID frame is distorted.

27. The apparatus of claim 19, wherein the communication device is a user equipment or a network device.

28. A computer-readable medium storing code for wireless communications, comprising:
code for decoding, at a communication device, a silence insertion descriptor (SID) frame to identify a pattern associated with the SID frame;
code for correlating the pattern with a reference pattern for the SID frame; and
code for determining whether the SID frame is de-synchronized based on the correlating.

29. The computer-readable medium of claim 28, wherein code for determining whether the SID frame is de-synchronized comprises code for determining that a consecutive N number of SID frames fail to match the reference pattern, wherein N is an integer.

30. The computer-readable medium of claim 28, wherein the code for decoding the SID frame to identify the pattern associated with the SID frame is triggered in response to detecting an SID bad-frame.
